(19) United States
(12) Patent Application Publication
(10) Pub. No.: US 2006/0027771 A1
(43) Pub. Date: Feb. 9, 2006

(54) Reciprocating ball type angle valve

(76) Inventor: Hans D. Baumann, Rye, NH (US)

Correspondence Address: Hans D. Baumann Ph.D., 32 Pine Street, Rye, NH, 03870, US

(21) Appl. No.: 10/912,681

(22) Filed: Aug. 6, 2004

(51) Int. Cl. F16K 47/00

(52) U.S. Cl. 251/119

(57) ABSTRACT

The device described herein is a valve suitable for the control or shut-off of fluid flow in a piping system. It comprises a valve housing having inlet and outlet ports and a cylindrical bore whose axis is slanted at about 90 degrees in relation to the axis connecting said outlet port. A ball or closure member being slidingly arranged within said cylindrical bore and being capable of making tight contact with a flexible and suitably retained metal seal interspaced between said inlet and outlet ports. Additional means allow for the ball or closure member to connect to a conventional actuating device having linear output motion.

### TECHNICAL FIELD

The control valve described herein makes known an apparatus enabling the control of high-pressure fluids within a piping system capable of closing or modulating flow of gaseous or liquid fluids following the commands of a reciprocating actuating device.

### BACKGROUND

Control valves are commonly used to control the fluid passing through a pipe. As known to those skilled in the art, a control valve regulates the rate of fluid flow as the position of the valve plug is changed by an actuator. There are three important features of a control valve, such as a globe valve, that it must contain the fluid without external leakage, that it must be able to withstand the pressure and temperature of the fluid, and that the fluid forces acting on the plug or closure element should not cause instability nor prevent the plug from shutting the valve off.

Quite often control valves have to perform under elevated pressure and temperature conditions. While valves with a single seat shut-off configuration and an unbalanced plug provide good service in these applications, they do require substantial forces that have to be provided by an actuator in order to overcome the effects of high fluid pressure acting on such unbalanced plug surfaces. For example, a one inch valve plug needs more than 800 lbs force to close against 1000 psi fluid pressure.

Such actuator force requirements can be quite expensive and such valves face other problems such as stability of operation. A typical example of such a single seated valve is shown in U.S. Pat. No. 4,474,356.

One typical way of alleviating these problems in prior art is the use of a cage with dual seating surfaces for the plug. My prior inventions, shown in U.S. Pat. Nos. 6,536,472 B2 and 3,805,839, describe such a solution. While capable of performing the required tasks, this is a very expensive solution due to the extra, precision machined, parts and due to the extra heavy bonnet bolting that is required to lock the cage within the valve housing. Finally, these valves have an additional problem of absorbing thermal expansion of the cage, especially if cage and housing have to be made of different materials. Another added expense is posed by the requirements to have the seating surfaces of the plugs lapped against opposing surfaces in the seat rings in order to obtain tight shut-off.

### SUMMARY

The object of my invention is a control valve assembly of low cost and compact configuration, requiring neither cage nor seat rings

A further objective is to provide for substantial reduction of forces created by fluid pressure acting on the valve plug or closure member thereby eliminating the need for larger and expensive actuating devices.

Yet another objective of my invention is to provide a control valve with parts that can be made from similar materials and, utilizing the use of one flexible valve seal can overcome the adverse effects of thermal expansion on the sealing capabilities of the valve closure member. Finally, by utilizing a finely polished ball which, when compressing a flexible metal seal ring, can provide tight shut-off without resorting to conventional and time consuming lapping procedures. While ball valves are well known in the art, they are utilizing rotary motion for closing or opening of a valve. This in turn requires rotating actuating devices. Such devices are inherently more complicated than simple reciprocating actuators such as a piston and cylinders since rotary actuators require a mechanical interface in order to convert linear into rotary motion.

In accordance with another aspect of my invention, a gradually enlarging flow passage provides a desired flow characteristic by utilizing a characterized opening of a outlet port co-operating with the spherical portion of a ball or closure member.

### BRIEF DESCRIPTION OF THE DRAWINGS

FIG. 1 is a central, cross-sectional view of a preferred embodiment of my invention.

FIG. 2 is a partial, cross-sectional view of the outlet portion of the valve housing along the lines 2-2 in FIG. 1.

FIG. 3 is a partial, central, cross-sectional view of the combined inlet port-retainer and the closure element in an alternative configuration.

### DETAILED DESCRIPTION

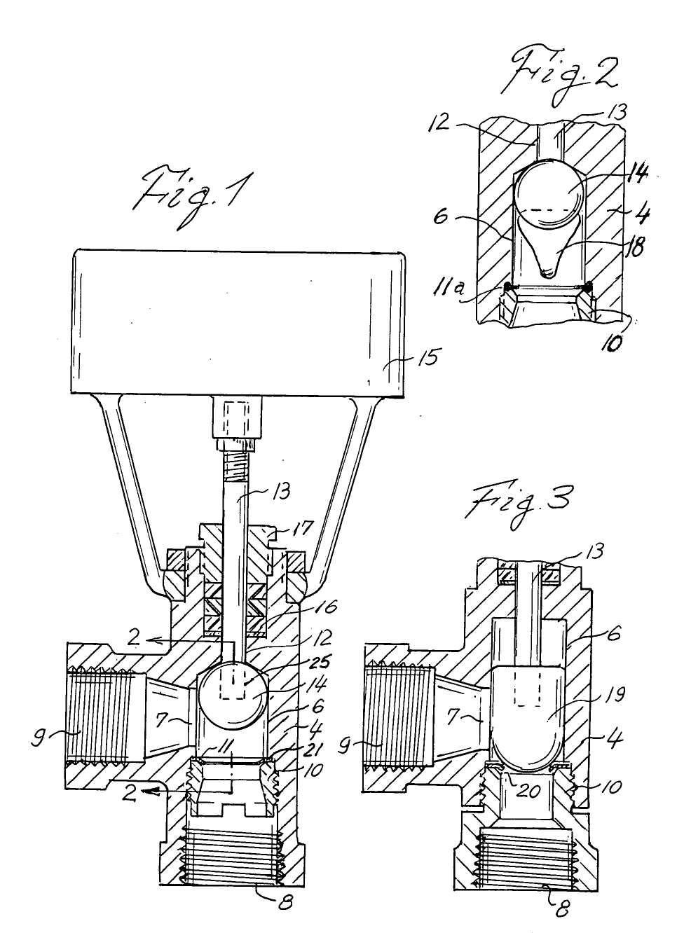

Referring to FIG. 1, my reciprocating ball valve comprises a housing 4 preferably made from stainless steel or bronze, and having a central, reduced bore 6, a concentric inlet port 8, and an outlet port 9 whose axis is off-set from that of central bore 6. Housing 4 furthermore has an opening 7 intersecting said central bore 6 at an angle of about 90 degrees from the axis of bore 6. Housing 4 is configured to attach in a suitable manner to fluid conducting pipelines. Suitable pipe threads are shown at inlet port 8 and outlet port.9 respectively. However it is understood that the housing 4 may also incorporate a pair of pipeline flanges. A retainer 10 is threaded into the upper portion of inlet port 8. Said retainer furthermore is capable of compressing and retaining a flexible seal 11 preferably made from hardened stainless steel at the intersection of the inlet port 8 and the reduced diameter of central bore 6 The upper portion of housing 4 has a central bore 12 slidingly engaging a valve stem 13 whose lower portion is suitably fastened to a closure member 14, preferably of spherical shape and made of stainless steel or similar hardened and corrosion resisting material, while the upper terminating end of said valve stem attaches to an actuating device 15 of conventional design and which is actuated by pneumatic, hydraulic or electrical means. Said closure member 14 can now be moved up or down while engaged in the closely fitted bore 6, serving as a guide for said closure member.

While seal 11 typically is made from stainless steel or a nickel alloy, there are certain chemical applications where seal 11 may be made from a corrosion resistant plastic such as Teflon®, or, from an elastomeric material as shown as 11a in FIG. 2. Finally it may be desirable to have first a deformable plastic seal ring for primary contact with the spherical surface of closure member 14 and then followed by a flexible metal ring 20, for backup (see FIG. 3). This is especially desirable if bubble-tight shut-off is to be maintained.

Housing 4 additionally features a hollow indenture 16 and an adjustable packing box 17.

As shown in FIG. 2, opening 7 is intersecting with the central bore 6 at an angle of about 90 degrees, and may be configured with an opening having a desired characterized shape 18. Thus opening 18 gets gradually exposed to fluid flow by the upward movement of closure member 14. This, in turn, results in a nearly perfect linear or an exponential relationship between fluid flow, at constant differential pressure, and the travel of closure member 14, when motivated by the actuating means 15.

The inside diameter of the seal ring 11 is typically slightly less than 80% of the diameter of closure member 14. The closure member has a central bore 25 receiving therein the lower portion of stem 12. the latter being suitably secured.

FIG. 3 shows an alternative design. Here the closure element is a cylinder 19 having a spherical lower portion capable of sealingly interacting with seal 11. Such a cylindrical shape of the closure member may be desirable when high fluid pressures are encountered which, in turn, may require extra guiding in order to prevent vibration.

FIG. 3 furthermore illustrates the use of a double plastic/metal seal configuration 20. Another modification shown in FIG. 3 is the combination of the lower portion of housing 4 incorporating inlet port 8 with retainer 10. Such a combination is then suitably secured to the remaining portion of housing 4.

Compared to conventional plug valves, the actuating device in my invention needs substantially less force in order to push closure member 14 against seal ring 11 and the fluid pressure exerted from inlet port 8. The reason for this is, that the bore of the seal ring 11 typically is only about 70% of that of a conventional valve seat ring bore for an equivalent amount of fluid flow. Therefore, the fluid forces that a plug, or in this case a ball, has to overcome are 51% less. The reason why a 70% seal diameter is sufficient lies in the fact that my angle style body configuration is much more efficient to conduct fluid flow than the typically complex flow pattern in a globe valve will allow. Further cost reductions are achieved by the use of a commercial ball instead of a custom machined valve plug and by the use of a simple, stamped seal ring replacing a complex, machined seat ring. A final cost saving is achieved by utilizing seal 11 as both, a closure means to prevent fluid flow between inlet and outlet ports when my valve is closed, utilizing the inner circumference of seal 11 in contact with closure element 14, but also as a seal to prevent leakage by the retainer 10 when the outer circumference of seal 11 is pressed against shoulder 21 by retainer 10.

While the invention has been explained in preferred configurations, the description is not intended to be construed in a limiting sense. Various modifications and combinations will be apparent to those skilled in the art. For example, the lower portion 8 of the housing 4 and the retainer 10 may be combined and then suitably attached to the rest of housing 4. Such a solution is used for sanitary applications. Also, it is foreseen that the housing may incorporate flanges able to connect to similar flanges of a piping system. It is also foreseen that the inlet and outlet ports may incorporate sanitary fittings in order to be connected to sanitary piping, and that the direction of flow might be reversed from that shown. It is more cost effective to use a commercial metal ball for the closure member, Nevertheless a cylindrical valve plug with a lower spherical contour may be used, or a guide ring could be added above the ball, for certain applications, especially for higher pressure applications. Finally, the angle of slant of bore 7 can be varied from the preferred 90 degrees in order to suit individual size requirements and the flexible metal seal may be replaced or supplemented by a seal ring made from a plastic material or, made of rubber.

1. A reciprocating ball type angle valve comprising a housing having an inlet port and an outlet port, said inlet port terminating in a reduced diameter portion extending above and communicating with said outlet port, said reduced diameter portion furthermore engaging a sliding closure member whose lower periphery has the shape of a sphere, at least one flexible seal suitably mounted and retained at the intersection between said inlet port and the reduced diameter portion.

2. A reciprocating ball type angle valve as described in claim 1, wherein said sliding closure member has the configuration of a sphere capable of being motivated by a valve stem within said reduced diameter portion.

3. A reciprocating ball type angle valve as described in claim 1, wherein said seal comprises at least one thin metal ring having an inner and one outer circumference and being suitably retained and sealed at the intersection between said inlet port and the reduced diameter portion and being capable of having its inner circumference flexed in order to conform to the shape of said movable closure member when the latter is in contact with said metal ring in order to prevent fluid flow.

4. A reciprocating ball type angle valve as described in claim 1, wherein the outlet port is angularly offset from said inlet port and wherein said flexible seal is retained by a threaded retainer, the latter being located within the upper portion of said inlet port, said flexible seal furthermore has an inner and one outer circumference and wherein the inner circumference is capable of sealingly interacting with said closure member while the outer circumference is statically retained and capable of sealing against a shoulder located at the intersection of the inlet port and said reduced diameter portion.

5. A reciprocating ball type angle valve as described in claim 2, wherein said movable closure member incorporates a drilled socket bore originating at a point opposed to the area of the element capable of being in contact with said sealing means and able to receive therein a portion of said valve stem.

6. A reciprocating ball type angle valve as described in claim 5, wherein said valve stem has a lower terminating end that is suitably fastened and retained within said drilled socket bore.

7. A reciprocating ball type angle valve as described in claim 1, wherein said seal further comprises one or more deformable plastic rings, all suitably fastened and sealingly retained at the intersection of said inlet port and said reduced diameter portion.

8. A reciprocating ball type angle valve as described in claim 1, wherein said seal further comprises one or more flexible metal sealing rings and one or more deformable plastic rings in series, all suitably fastened and sealingly retained at a shoulder located at the intersection of said inlet port and said reduced diameter portion

9. A reciprocating ball type angle valve as described in claim 2, wherein said valve stem extends to the exterior of said housing where it is sealed by means of a suitable valve packing located on top of said housing.

10. A reciprocating ball type angle valve as described in claim 1, wherein a portion of said outlet port intersecting with said reduced diameter portion has a contoured cross section in order to vary the rate of fluid flow through it in a desired proportion to the movements of said sliding closure member.

11. A reciprocating ball type angle valve as described in claim 4, wherein the lower portion of said housing containing said inlet port and said retainer are combined and together are suitably fastened to the remainder of said housing.

12. A reciprocating ball type angle valve as described in claim 1, wherein said flexible seal is made from a suitable elastomer.
